(19) United States
(12) Patent Application Publication
(10) Pub. No.: US 2023/0135169 A1
(43) Pub. Date: May 4, 2023

(54) SLICING OF FOOD PRODUCTS

(71) Applicant: Textor Maschinenbau GmbH, Wolfertschwenden (DE)

(72) Inventor: Josef Mayer, Memmingerberg (DE)

(21) Appl. No.: 17/968,325

(22) Filed: Oct. 18, 2022

(30) Foreign Application Priority Data
Oct. 29, 2021 (DE) 102021128284.5
Dec. 20, 2021 (DE) 102021133915.4

(51) Int. Cl. B26D 1/08; B26D 7/06; B26D 7/26

(52) U.S. Cl. CPC B26D 1/08; B26D 7/0625; B26D 7/26; B26D 2210/02

(57) ABSTRACT

The invention relates to an apparatus for the single-track or multi-track slicing of food products, in particular a high-performance slicer, having a product feed that feeds products to be sliced and disposed on a product support on one track or on multiple tracks in a feed direction to a cutting region in which a cutting blade moves, in particular in a rotating and/or revolving manner, in order to slice the fed products in a cutting plane, which extends perpendicular to the feed direction, at a predefined or predefinable cutting frequency by means of the cutting blade; and having a dividing device that has at least one holder, which is arranged in the region of the cutting plane, for at least one elongated separation element, which extends in a dividing plane extending in parallel with the cutting plane, and a drive for the holder by which the holder can be excited to perform to-and-fro movements perpendicular to the feed direction at a dividing frequency in order to divide the front ends of the products by means of the separation element in parallel with the feed direction so that, in a respective cutting process, a plurality of product parts are cut off from a respective front product end by means of the cutting blade, wherein a control device is provided, and wherein the drive for the holder comprises a drive that can be controlled by means of the control device, in particular a servomotor.

The invention relates to an apparatus for the single-track and multi-track slicing of food products, in particular a high-performance slicer, the apparatus having a product feed that feeds products to be sliced and disposed on a product support on one track or on multiple tracks in a feed direction to a cutting region in which a cutting blade moves, in particular in a rotating and/or revolving manner, in order to slice the fed products in a cutting plane, which extends perpendicular to the feed direction, at a predefined or predefinable cutting frequency by means of the cutting blade; and

having a dividing device that has at least one holder, which is arranged in the region of the cutting plane, for at least one elongated separation element, which extends in a dividing plane extending in parallel with the cutting plane, and a drive for the holder by which the holder can be excited to perform to-and-fro movements perpendicular to the feed direction at a dividing frequency in order to divide the front ends of the products by means of the separation element in parallel with the feed direction so that, in a respective cutting process, a plurality of product parts are cut off from a respective front product end by means of the cutting blade.

In known apparatus of this type, the excitation of the holder, for example, takes place by a pneumatic cylinder. The disadvantage here is the performance that is limited by the design. Typically, only approximately 5 to 6 to-and-fro movements per second, and thus only approximately 300 to 400 to-and-fro movements per minute (H/min), are possible.

This means that the slicing of the products can also only take place at a comparatively low cutting frequency (rotational speed of the cutting blade) of at most approximately 600 revolutions per minute (rpm). The reason for this is that the front product ends can move themselves due to the friction by the separation element moving to and fro comparatively slowly, and indeed also when—as is usual in practice—the front product ends are supported over at least a part of their periphery by a product passage, also designated as cutting spectacles or as a cutting frame, that has an opening for a respective front product end for the or each track. In practice, these openings are indeed usually not perfectly adapted to the contour of the products, which leads to the mentioned disadvantageous movability of the front product ends due to the friction at the separation elements. Due to this poor positioning accuracy of the front product ends, a poor slice quality, and thus a deficient quality of the portions formed from the plurality of cut-off slices, result during the slicing by means of the cutting blade. It is in particular observed that the slices tend to have an irregular wedge shape.

So far, this can only be avoided by—as mentioned—cutting more slowly, i.e. selecting a comparatively low cutting frequency, whereby the performance of the slicing apparatus, and thus of the entire production line to which the respective slicing apparatus belongs, is restricted.

When product slices or—in the case of a greater thickness—product pieces are mentioned within the framework of this disclosure, it is understood that these product slices or product pieces consist of a plurality of product parts due to the division of the front ends of the products by means of the dividing device. The division of the front product ends, for example a quartering, is generally known. When quartering of the products, not a single product part in the form of a whole slice or a whole piece is therefore actually cut off during the cutting off of a slice or a piece from the front product end by means of the cutting blade, but rather four product parts are cut off that produce a product slice or product piece when combined.

It is the object of the invention to avoid the aforesaid disadvantages.

This object is in each case satisfied by the features of the independent claims.

In the slicing apparatus in accordance with the invention, which is in particular a high-performance slicer, a control device is provided, wherein the drive for the holder comprises a drive that can be controlled by means of the control device, in particular a servomotor.

The invention furthermore relates to a method, in which provision is made that the holder is excited by means of a controllable drive, in particular a servomotor.

The invention further relates to the use of a drive that can be controlled by means of a control device, in particular a servomotor, in a slicing apparatus, in particular in a high-performance slicer, the apparatus having a product feed that feeds products to be sliced and disposed on a product support on one track or on multiple tracks in a feed direction to a cutting region in which a cutting blade moves, in particular in a rotating and/or revolving manner, in order to slice the fed products in a cutting plane, which extends perpendicular to the feed direction, at a predefined or predefinable cutting frequency by means of the cutting blade; and having a dividing device that has at least one holder, which is arranged in the region of the cutting plane, for at least one elongated separation element, which extends in a dividing plane extending in parallel with the cutting plane, and a drive for the holder by which the holder can be excited to perform to-and-fro movements perpendicular to the feed direction at a dividing frequency in order to divide the front ends of the products by means of the separation element in parallel with the feed direction so that, in a respective cutting process, a plurality of product parts are cut off from a respective front product end by means of the cutting blade, and indeed as a drive or as a component of a drive for exciting the holder.

When the term “servomotor”, “servomotor drive” or similar is used in the following, then—unless otherwise stated—it is only used as an example of a controllable drive for the sake of simplicity, i.e. other controllable/regulable drives can also be used to excite the holder. Such drives are generally known to the skilled person so that they do not have to be looked at in more detail here. Such drives are in particular characterized in their control in that they are operated in a closed control loop.

Due to the use of a servo drive for the holder and thus for the separation element, which can, for example, be configured as a knife, as a blade, or as a saw blade, numerous advantages and advantageous further developments of the invention result that are indicated below and that will also be looked at in more detail elsewhere.

A controllable drive, for example, allows a high precision and in particular a dynamic switching on and switching off of the to-and-fro movements of the holder. Furthermore, a controllable drive, in particular a servomotor, is characterized by a pronounced energy efficiency. The controllable drive can, for example, be drive-effectively connected to the holder via a mechanical transmission that can in particular comprise an eccentric element. In particular such a design makes it possible to implement significantly higher dividing frequencies, i.e. to generate a significantly larger number of to-and-fro movements per minute (H/min) of the separation element than was possible in accordance with the prior art, e.g. by means of a pneumatic cylinder. Dividing frequencies of up to or even more than 1000 H/min are possible in accordance with the invention. It has been shown that this can even be implemented without specific measures for balancing. Alternatively, it is also possible to provide a linear servomotor, i.e. to work without an eccentric element. As already mentioned, any desired controllable/regulable drives can generally be used.

With the invention, it is advantageously possible to excite the holder in a controlled manner such that the to-and-fro movements of the holder are synchronized with the cutting movements of the cutting blade. In particular, it is possible to synchronize the dividing frequency and the cutting frequency. Any transverse movements of the front product ends possibly still occurring due to the dividing device then do not have a disadvantageous effect, i.e. irregular product slices or product pieces are avoided, so that the quality of the slices or pieces and thus the portion quality can be considerably improved. The servomotor can, for example, engage at a single side of the holder to move the separation element in this manner.

Specific embodiments of the holder and arrangements of one or more separation elements will be looked at in more detail elsewhere. If a transmission is provided between the drive and the holder, it can comprise a crank drive, for example. An eccentric element can be used here that is comparatively small and that has an eccentricity, for example, of 2 to 15 mm so that an effective stroke of the holder of 4 to 30 mm results.

The crank drive can be a thrust crank drive. The thrust crank drive can be designed centrally or eccentrically, wherein the latter is inter alia to be understood such that an articulation point of the thrust crank drive at the holder lies in a different horizontal plane than the servomotor or an axis of rotation of a rotating drive member of the servomotor, for example, an output shaft of the servomotor.

As will be discussed in more detail elsewhere, the holder can comprise two holder parts that are movable relative to one another and that each have at least one separation element, said separation elements not extending in the same direction. The servomotor can engage at the one holder part, wherein the resulting to-and-fro movement of this holder part is converted into the movement of the other holder part that is thus not set into a to-and-fro movement directly by the servomotor, but rather via the other holder part. This mechanical coupling of the two holder parts can take place via a slot guide, for example, by a straight slot guide that extends inclined with respect to both directions of the to-and-fro movements of the two holder parts. In such an arrangement, the transmission ratio between the two holder parts can amount to i=2, whereby it is achieved that the stroke of the one holder part, for example a holder part that can be moved to and fro in the vertical direction, amounts to 50% of the other holder part that in particular moves to and fro in the horizontal direction and that is excited directly by means of the controllable drive for this purpose. When a “direct” excitation of the holder or of one of the plurality of holder parts of the holder by means of a controllable drive is mentioned in this connection, this can also be understood as an arrangement in which an additional mechanism, in particular a transmission, is provided between the servomotor and the holder or the holder part. A direct driving by the controllable drive is, in contrast, not present if, as in the example explained above, one of the plurality of holder parts is excited by another holder part, for example, via the slot guide mentioned.

As already mentioned, the use in accordance with the invention of a controllable drive enables a time coordination of the movement of the separation element with other parameters of the cutting operation, for example, with the cutting movement of the cutting blade or with the operation of the product feed. A synchronization of the dividing frequency and the cutting frequency is in particular made possible. In this respect, a phase shift between the movements of the separation element, on the one hand, and of the cutting blade, on the other hand, are also set in a respectively desired manner. For example, the movement of the separation element can be coordinated with the movement of the cutting blade such that the movement of the separation element additionally stabilizes a respective front product end in order to counteract a transverse movement when the cutting blade is moved through the front product end to cut off a slice or a piece.

The use of a controllable drive furthermore makes it possible not only to generate a strictly periodic to-and-fro movement of the holder and thus of the separation element, but the movement profile and/or the speed profile of the separation element can generally be varied as desired and can be adapted to generally any desired aspects of a respective cutting operation and can also be changed in a highly dynamic manner. For example, the separation element movement profile and/or the dividing frequency can be controlled in dependence on the rotational speed of the cutting blade and/or on the position of the cutting blade and/or on the product feed speed and/or on a respective set thickness of the slices or pieces.

Due to the possibility of a dynamic control of the drive, it can also be achieved that the holder is only excited when it is also actually required due to the cutting operation. If, for example, the slicing apparatus performs blank cuts or is being loaded, the servo drive can be switched off. Thus, it can, for example, be achieved on a coordination of the drive for the holder with the product feed that the separation element only moves when the product feed also actually feeds a respective product.

Furthermore, it is advantageously possible to use the controllable drive to be able to estimate forces acting on the separation element. For example, the current consumption and/or a tracking error and/or the voltage development of the servomotor or of the control device controlling it, in particular regulation electronics, can be used. By means of these data determined by the servomotor itself, the operation of the servomotor, but also the operation of other components of the slicing apparatus can thus be adapted, in particular the operation of the cutting blade. For example, the rotational speed of the cutting blade and/or the dividing frequency and thus the speed of the separation element can be adapted to the consistency or also to other properties of the respective products to be sliced. Thus, the product feed can, for example, be slowed down if the product is comparatively hard since, for example, slicing is performed in a comparatively cold state, in particular a frozen state. Alternatively, the speed of the product feed can be increased when a comparatively soft product is being sliced. The fact is utilized here that the forces acting on the separation element vary in dependence on the product consistency, i.e. the controllable drive or its control/regulation electronics can be used to determine a measure of the forces acting on the separation element. It is hereby also possible to detect an overloading of the separation element and to adapt the operation of the slicing apparatus, in particular of the dividing device, such that the separation element is subjected to less stress and is in particular not overloaded, i.e. an overloading can hereby be avoided. Damage to or destruction of the separation element, for example a breakage of a blade forming the separation element, can in particular be avoided. By determining the forces acting on a respective separation element, for example, a blade break can also be recognized as such since a broken blade or a blade that is no longer present at all due to a break “reports back” different forces to the electronics of the controllable drive than an intact blade that is cooperating with the respective product as intended.

Further advantageous embodiments of the invention are set forth in the following and also in the dependent claims, in the description of the Figures, and in the Figures themselves.

The cutting blade can be a scythe-like blade that only rotates about a blade axis, and indeed at the cutting frequency. Alternatively, the cutting blade can be a circular blade that rotates about its own blade axis and furthermore revolves in a planetary motion about an axis of rotation extending offset in parallel from said blade axis. The cutting frequency in the case of a circular blade refers to this revolution. With a circular blade, cutting frequencies of more than 600 rpm can be achieved without problem; with a scythe-like blade, significantly higher cutting frequencies are possible than with a circular blade that can, for example, lie at considerably more than 1000 rpm and can amount to up to 1800 to 2000 rpm. The term high-performance slicer refers to such cutting speeds, wherein it is also to be considered that such slicers can typically slice a plurality of products at the same time at said cutting speeds, for example four or six products disposed next to one another, in particular sausage bars or cheese bars. However, such slicers can also slice other products such as cheese or ham. Such slicers are also used for piece cutting, in particular for slicing fresh meat, wherein the cutting frequency is not the same for all the products. The invention preferably relates to such high-performance slicers.

The plurality of products are preferably sliced at the same time. Irrespective of whether a single product or a plurality of products are sliced simultaneously, in some embodiments, the position of the blade in a plane extending perpendicular to the feed direction relative to the product feed, and thus relative to the product support, can be set.

The control device can be configured to control the controllable drive in dependence on a respective current cutting operation. This was already looked at above.

This can, for example, take place in dependence on the cutting frequency of the cutting blade. Alternatively or additionally, this can take place in dependence on the mentioned position of the cutting blade in the cutting plane relative to the product feed. Alternatively or additionally, this can take place in dependence on an operating state of the product feed, for example in dependence on the feed speed. Alternatively or additionally, this can take place in dependence on whether or not product parts are currently being cut off or not, wherein, for example, no product parts are cut off when the slicing apparatus performs blank cuts or is being loaded, i.e. due to a respective blank cutting phase or loading phase. Alternatively or additionally, this can take place in dependence on data that are determined by means of the servomotor, in particular on data that relate to forces acting on the separation element, as was already explained above.

The holder can be excited to a dividing frequency of more than 300 H/min (to-and-fro movements per minute). The holder can in particular be excitable to a dividing frequency of more than 600 H/min, in particular from 800 to 1200 H/min.

The control device can be configured to excite the holder at a dividing frequency that is equal to the cutting frequency of the cutting blade or such that the dividing frequency of the cutting blade is a whole-number multiple of the cutting frequency.

In this respect, the cutting frequency of the cutting blade can amount to more than 600 rpm, in particular more than 800 rpm, in particular more than 1000 rpm, in particular more than 1200 rpm.

An axis of rotation of a drive member of the drive, in particular an axis of rotation of an output shaft of a servomotor, can intersect the cutting plane, wherein in particular the axis of rotation extends in parallel with the feed direction or at an angle of less than 10° to the feed direction.

The controllable drive, in particular a servomotor, can be drive-effectively connected to the holder via a mechanical transmission. In this respect, provision can in particular be made that the transmission is configured as a crank drive or comprises a crank drive. The crank drive can in particular be configured as a thrust crank drive.

The transmission can comprise an eccentric element.

A coupling element of the transmission, which is, for example, configured in the form of a coupling rod, can, with its one end, be eccentrically connected in an articulated manner to a drive member of the drive rotating about an axis of rotation, in particular an axis of rotation of an output shaft of a servomotor, with respect to the axis of rotation and can, with its other end, engage directly or indirectly at the holder, in particular be connected in an articulated manner. The axis of rotation of the drive member and the point of engagement of the coupling element can be disposed in a common horizontal plane or in different horizontal planes.

The eccentricity of an eccentric element of the transmission or of the eccentric articulated connection of the coupling element can be between 2 mm and 20 mm, in particular between 2 mm and 16 mm, in particular between 10 mm and 15 mm.

The holder can be arranged at a single-part or multi-part product passage, which forms the front end of the product feed and is configured to support the front product ends, such that the holder performs the to-and-fro movements relative to the product passage, wherein the product passage has a passage, in particular an opening, for a respective front product end for the or each track and the elongated separation element traverses the or each passage. In this respect, provision can in particular be made that the holder is carried by the product passage and/or is displaceably supported at the product passage.

In some embodiments, provision can be made that the or each passage is formed by a circular, oval, egg-shaped, square or rectangular opening that is bounded by an interrupted or uninterrupted peripheral support surface for a respective front product end in order to support a respective product end all around, with or without interruptions in the peripheral direction.

Such a product passage is also designated as cutting spectacles. Other common terms—depending on the specific design of the product passage—are a cutting edge or a molded tray. If the product passage is formed in multiple parts, for example has a lower part and an upper part, the individual parts of the product passage can be adjustable relative to one another in order in this manner to achieve an optimum adaptation to the contour of the products to be sliced in each case. The or each opening can also be bounded by more than two parts of the product passage, which are adjustable relative to one another, to be able to further optimize the adaptation to the product contour.

Slicing apparatus, in particular high-performance slicers, having such product passages or cutting spectacles are generally known. The product passage provides a support of the front product ends during the slicing. The passages do not have to be openings surrounding the respective product ends along the full periphery. Shell-shaped passages, e.g. having a U-shaped cross-section in each case, are also possible, for example. In this case, an upward support of the front product ends does not take place. The dividing device can generally be provided at product passages of any desired design. An all-round support of the front product ends can also take place by an interrupted peripheral support surface in that, for example, a plurality of support sections are arranged distributed and spaced apart from one another in the peripheral direction.

In some embodiments, provision can be made that the product passage is arranged in front of the cutting plane, viewed in the feed direction. During operation, the front ends of the products are therefore each first divided by means of the separation element in parallel with the feed direction before a then multi-part product piece is cut off from the front product end by means of the cutting blade. As initially already mentioned, these product parts can be parts of a slice-shaped product piece, i.e. the product parts form a product slice when combined, wherein alternatively the dividing device can also be used for dicing the products. The speed of the product feed and the cutting frequency are then matched to one another such that a thickness of the respective product pieces to be cut off is set that is in turn matched to the dividing device, in particular with regard to the number and arrangement of the separation element or of the separation elements, so that the cut-off product parts at least approximately have a cube shape and—in contrast to a smaller thickness—do not have the shape of partial slices.

The product passage can be configured as a counter-blade for the cutting blade that cooperates with the cutting blade for the cutting off of the product parts from the front product ends. In a slicing apparatus such as in particular a high-performance slicer, a counter-blade for the cutting blade is also designated as a counter-blade or a cutting edge.

In some embodiments, provision can be made that the elongated separation element extends within the product passage so that the elongated separation element traverses the or each passage, viewed in the feed direction, between an entry plane into the passage and an exit plane from the passage. For this purpose, provision can be made that the product passage has a somewhat greater thickness, viewed in the feed direction, than a conventional product passage without an integrated separation element.

In some embodiments, provision can be made that the or each passage is traversed by a plurality of elongated separation elements that extend at an angle different from zero to one other and in dividing planes spaced apart in parallel from one another. In this respect, the elongated separation elements can extend perpendicular to one another, in particular such that a respective front product end is quartered (“quartering”).

In some embodiments, provision can be made that, in a multi-track design, the product passage has a passage for each track and all the passages are traversed, on the one hand, by a common elongated separation element that extends in a first direction and each passage is additionally traversed by at least one further elongated separation element that extends in a second direction different from the first direction, wherein the second direction in particular extends perpendicular to the first direction. In this respect, provision can in particular be made that the first direction extends horizontally and the second direction extends vertically.

The term “vertical” is used here in connection with the separation elements and other components of the dividing device in the sense of extending perpendicular to the horizontal direction and in parallel with the cutting plane, even if the cutting plane is inclined with respect to the vertical—as is common in the practice of high-performance slicers.

Irrespective of whether the holder is arranged at a product passage or not, the holder can comprise a first holder part having at least a first elongated separation element and a second holder part movable relative to the first holder part and having at least a second elongated separation element that does not extend in parallel with the first elongated separation element. In this respect, provision can be made that the second elongated separation element extends perpendicular to the first elongated separation element.

The two holder parts can be arranged at a product passage, in particular a product passage such as is described in the present disclosure. In this respect, provision can in particular be made that both holder parts are carried by the product passage and/or are displaceably supported at the product passage.

In some embodiments, the two holder parts can be mechanically coupled to one another such that a to-and-fro movement of the one holder part taking place in a first direction is converted into a to-and-fro movement of the second holder part, wherein the latter takes place in a second direction that is different from the first direction and that in particular extends perpendicular to the first direction.

The conversion can take place in a purely mechanical manner and in particular by means of a straight slot guide extending inclined both with respect to the first direction and to the second direction.

In some embodiments, provision can be made that the first holder part is excited by means of the drive to perform the to-and-fro movement, in particular horizontal to-and-fro movement, taking place in the first direction, wherein this to-and-fro movement is converted into the to-and-fro movement, in particular vertical to-and-fro movement, of the second holder part taking place in the second direction.

In some further developments of the method in accordance with the invention, provision can be made that the controllable drive is here controlled by means of a control device in dependence on a respective current cutting operation. Possible aspects of the cutting operation on which the control of the drive can be made dependent have already been looked at above. These aspects also represent possible further developments of the method in accordance with the invention.

In the method, provision can be made that the to-and-fro movements of the holder are synchronized with the cutting movements of the cutting blade.

As mentioned above, it is possible to provide at least one horizontal separation element and at least one vertical separation element for the or each passage at a product passage. Such an orientation of the separation elements is not mandatory. For example, in dependence on a respective specific design of the support of the respective holder or holder part at the product passage or in dependence on the arrangement or design of the controllable drive, it can be advantageous if the orientation of at least one of the separation elements deviates from the horizontal or vertical orientation. In particular when there is only a single track and thus only one passage at the product passage, a separation element can extend inclined to the horizontal. In this respect, provision can furthermore be made that two separation elements are provided that extend perpendicular to one another. In particular, it is thus possible for the two separation elements to form an X arrangement, wherein such an X-shaped arrangement is also possible with a non-rectangular course of the two separation elements.

If the dividing device is arranged at a product passage, provision can be made that the product passage together with the holder can be separated from the drive, in particular without tools. The drive can hereby permanently remain at the slicing apparatus. This can be advantageous for cleaning purposes or for an operation in those applications in which no division of the front product ends in parallel with the feed direction is required, i.e. the dividing device is not used. The product passage with an integrated holder or an integrated separation element or integrated separation elements can then be exchanged with another product passage. The control device can deactivate the drive remaining at the slicing apparatus for such applications without a dividing device.

The product passage can, for example, be made completely from stainless steel. Alternatively, plastic can be used. The use of stainless steel has advantages with regard to respective hygiene and stability requirements.

In some embodiments, provision can be made that the separation element is not only fastened to the holder or a respective holder part with its free ends, but that, in the case of the provision of a product passage at which the holder or the holder part is arranged, a guiding of the separation element in the product passage additionally takes place. This can, for example, take place by means of rollers made from plastic or another material that are arranged in the corresponding sections of the product passage, in particular in vertical web sections between directly mutually adjacent passages of a product passage configured for a multi-track operation.

As already mentioned elsewhere, one advantage of using a controllable drive, in particular a servomotor, is that the movement of the or each separation element can be adapted to the respective operating situation, in particular to specific operating phases that do not represent the entire cutting operation. This, for example, relates to the control of the drive as part of a first-cut control and/or a cutting close to the end piece. For many products to be sliced in practice, the product start has a different cross-section with regard to shape and size than the rest of the product, i.e. when slicing a product, the front product end behaves differently than when slicing the rest of the product. This can be taken into account by a corresponding control of the drive, in particular to also ensure the stability of the front product end as part of a first-cut control. When the slicing of a product is nearing the end, the slicing by means of the cutting blade takes place comparatively closely to the product end piece, and thus in particular to a product holder engaging into the rear product end if such a product holder is available. Alternatively or additionally, in practice, the product ends can be acted on by upper conveyor belts or other devices to be held in position and can, if necessary, also conveyed. Such an operating situation can likewise be taken into account by an adapted control of the drive to the effect that the movements of the or each separation element take place such that the product end piece is spared in the sense of minimized transverse deflections. A tearing of the product end piece out of the product holder or a deflection relative to a device stabilizing the product from above or also from the side can hereby be avoided, while at the same time a high cutting quality can also be ensured during such a cutting close to the end piece.

If, as mentioned above, a transmission is provided between the controllable drive and the holder and this transmission has an eccentric element, a setting possibility can then be provided in that the eccentricity can be varied, for example by a variable attachment of an eccentric element to a rotating drive member of the drive, e.g. to the output shaft of a servomotor. An optimum eccentricity can hereby be set for each cutting frequency of the cutting blade. A whole-number ratio between the dividing frequency, on the one hand, and the cutting frequency, on the other hand, can hereby e.g. be ensured with a high accuracy, wherein a maximum stroke of the holder and thus of the separation element can simultaneously be ensured.

It has likewise already been mentioned above that a product passage, if provided, can be designed in multiple parts and can, for example, have a lower part and an upper part that can be moved relative to one another to provide setting possibilities, in particular for an adaptation to the respective product contour. A multi-part configuration of the product passage can also be designed such that the or each passage is bounded by four parts that are movable relative to one another so that the passage can be set with regard to shape and size and can thus be optimally adapted to a respective product to be sliced.

Irrespective of the specific design of the product passage, in a multi-track design having a plurality of passages, the product passage can be designed such that the passages can be set individually and independently of one another with regard to shape and/or size.

The invention will be described in the following by way of example with reference to the drawing. There are shown:

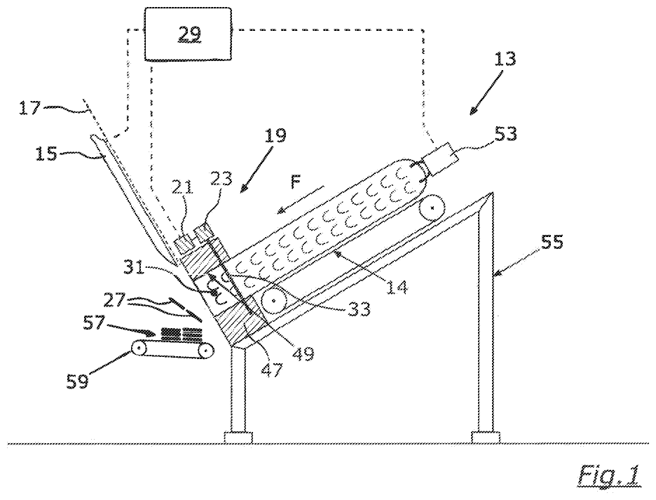

FIG. 1 schematically, in a side view, a high-performance slicer in accordance with the invention with a dividing device in accordance with an embodiment of the invention; and

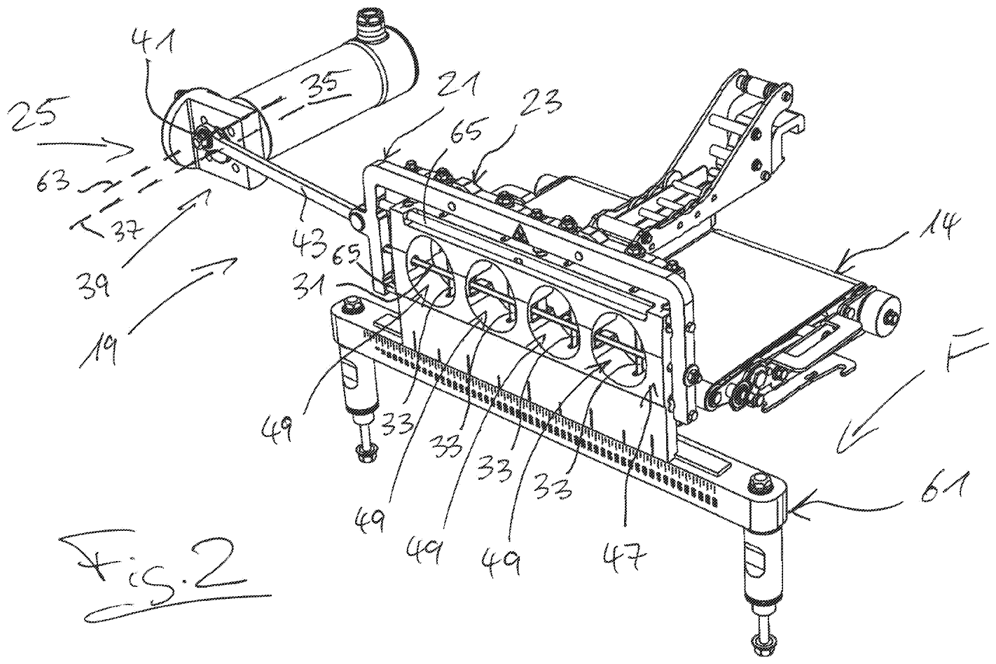

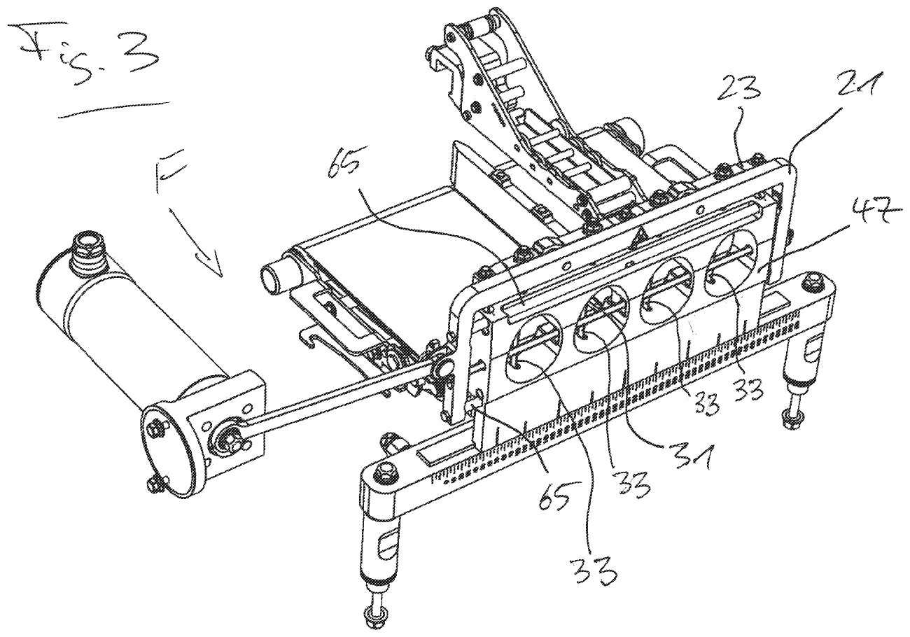

FIGS. 2 to 7 different views of a possible embodiment of a dividing device in accordance with the invention for attachment to a high-performance slicer for a multi-track slicing of food products.

The high-performance slicer in accordance with the invention, schematically shown in a side view in FIG. 1, comprises a frame 55 for support on the ground. A product feed 13 of the slicer 13 comprises a product support 14 that extends inclined to the horizontal, and thus to the ground, and that is formed here by an endless conveyor belt. Alternatively, a stationary support surface—for example a stainless steel sheet—can serve as a product support 14. Furthermore, the product feed 13 comprises a product holder 53, also designated as a gripper, that grips a respective product 11 to be sliced, for example a sausage bar having a circular cross-section, at the rear end and feeds the product 11 to a cutting region in a feed direction F during the operation of the slicer.

The slicer can be designed with one track or multiple tracks. In a multi-track design, a plurality of products 11 to be sliced are disposed next to one another, wherein a separate product holder 53 is provided for each product 11, wherein the product holders 53 can be operated independently of one another.

A variety of designs of such high-performance slicers are generally known to the skilled person. The dividing device 19 in accordance with the invention, which will be looked at in more detail below, can be provided at slicers of very different designs. For example, at least a part of the product support 14 can be pivotable and can, for example, be configured as a so-called loading rocker (not shown) to be able to load the product support 14 more easily in a lowered state. In addition, an upper conveyor, in particular in the form of an endless conveyor belt, can be provided for a respective product 11 and acts on the respective product 11 from above (not shown). A passive hold-down device for the product 11 can also be alternatively or additionally provided.

The front end of the product support 14 is formed by a product passage 47, which—as initially mentioned—is also designated as cutting spectacles and has a passage 49 in the form of an opening for the product 11 or—in a multi-track design—for each product 11, through which opening the respective product 11 is guided during operation. At the boundary of this opening 49, the front product end is supported all around.

The product passage 47 is configured as a counter-blade for a cutting blade 15, for example configured as a circular blade or scythe-like blade, that moves in a cutting plane 17. During the cutting operation, product parts 27 are continuously cut off from the front end of the product conveyed in the feed direction F by means of the product feed 13, wherein the cutting blade 15 and the product passage 47 cooperate for this purpose. The cut-off product pieces 27 fall onto a portioning belt 59 and form a portion 57 there. As soon as a portion 57 meeting predefined criteria has been completed, it can be transported away. During this transport away, the product 11 is not fed, i.e. the product feed 13 is temporarily inactive, so that the cutting blade 15, which continues to move, performs so-called blank cuts.

Such a cutting operation is generally known to the skilled person so that it does not have to be looked at in more detail here. The cutting frequencies possible with such a slicer, i.e. the possible blade rotation speeds, have already been looked at in the introductory part to which reference is hereby made.

For a respective cutting frequency of the cutting blade 15, the thickness of the cut-off product parts 27 depends on the feed speed of the product feed 13. In typical applications, the products 11 are cut into comparatively thin slices. However, it is also possible to cut off thicker product pieces.

As will be explained in more detail below in connection with FIGS. 2 to 7 with reference to a specific embodiment, a dividing device 19 is integrated into the product passage 47 in accordance with the invention, of which dividing device 19 only a first holder part 21 and a second holder part 23 are shown schematically in FIG. 1 that are each carried by the product passage 47 and displaceably supported at the product passage 47. Furthermore, the two holder parts 21, 23 are movable relative to one another, wherein a first holder part 21 can be excited to perform to-and-fro movements by means of a drive that is described in more detail below and that is not shown in FIG. 1. This is indicated in FIG. 1 in that the first holder part 21 is connected to a control device 29 that also controls the cutting operation and for this purpose is inter alia connected to a drive for the cutting blade 15 and to a drive for the product holder 53, as is indicated by the dashed lines in FIG. 1. The second holder part 23 is mechanically coupled to the driven first holder part 21 such that the second holder part 23 also performs to-and-fro movements. This concept is explained in more detail below with reference to the embodiment in accordance with FIGS. 2 to 7.

The opening 49—in a multi-track design, each opening 49—is traversed by two elongated separation elements 31, 33 that can e.g. be configured as a knife, a blade, a saw blade, or a wire. A horizontal separation element 31 is fastened to the first holder part 21 that traverses all the openings 49 in the horizontal direction in a multi-track design. A separation element 33 is fastened to the second holder part 23 for each opening 49, said separation element 33 extending perpendicular to the horizontal separation element 31 and therefore—despite the arrangement of the product feed 13 inclined to the horizontal and therefore despite the orientation of the cutting plane 17 inclined to the vertical—being designated as a vertical separation element 33 within the framework of the present disclosure for the sake of simplicity, as likewise already mentioned in the introductory part.

The horizontal separation element 31 and the vertical separation elements 33 thus extend in dividing planes that are spaced apart in parallel and that each extend in parallel with the cutting plane 17 and perpendicular to the feed direction F.

Due to this mutually crossing extent of the separation elements 31, 33 in each passage 49, a respective product is divided at its front product end within the opening 49 in a direction in parallel with the feed direction F so that no complete slices or pieces, but rather four individual product parts 27, are cut off from the front product end by means of the subsequently effective cutting blade 15. In other words, the products 11 are quartered here, i.e. a so-called “quartering” of the products 11 takes place.

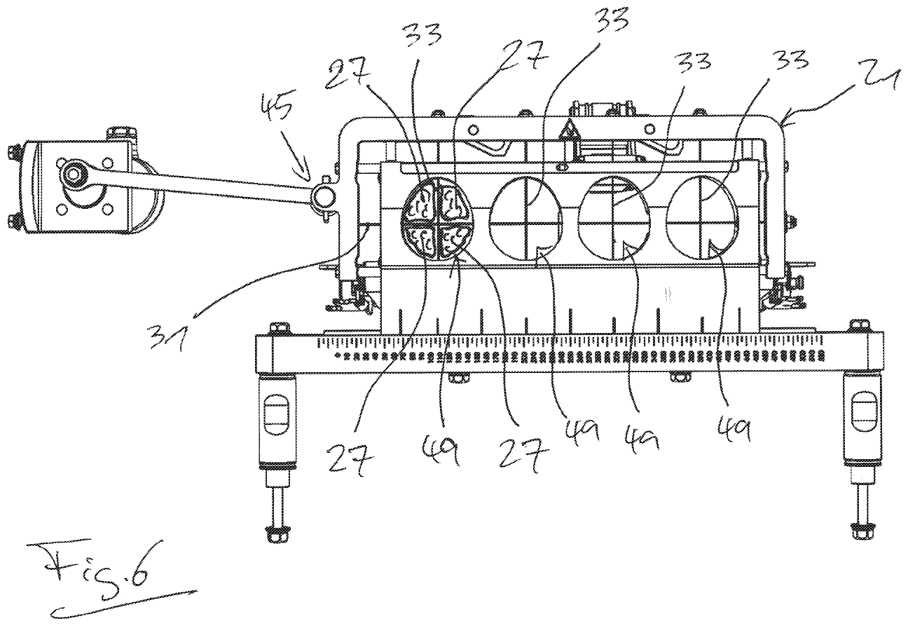

The embodiment of FIGS. 2 to 7 only shows the cutting region of a high-performance slicer in accordance with the invention that is otherwise not shown, wherein its cutting blade is also not shown. A carrier 61 is supported at the frame of the slicer, which is likewise not shown, and serves as a base for a product passage 47 that is, for example, made entirely from stainless steel and that is configured as a counter-blade for the cutting blade, not shown. The slicer is formed with four tracks, i.e. four openings 49—one for each track—are formed at the product passage 47, which is also designated as cutting spectacles in the following, and are each designed with an egg shape in the embodiment shown here (cf. in particular FIG. 6).

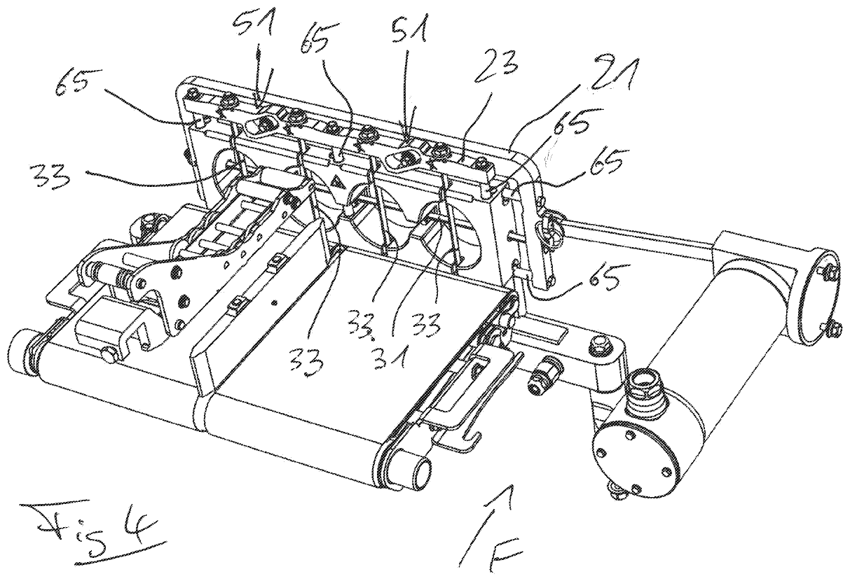

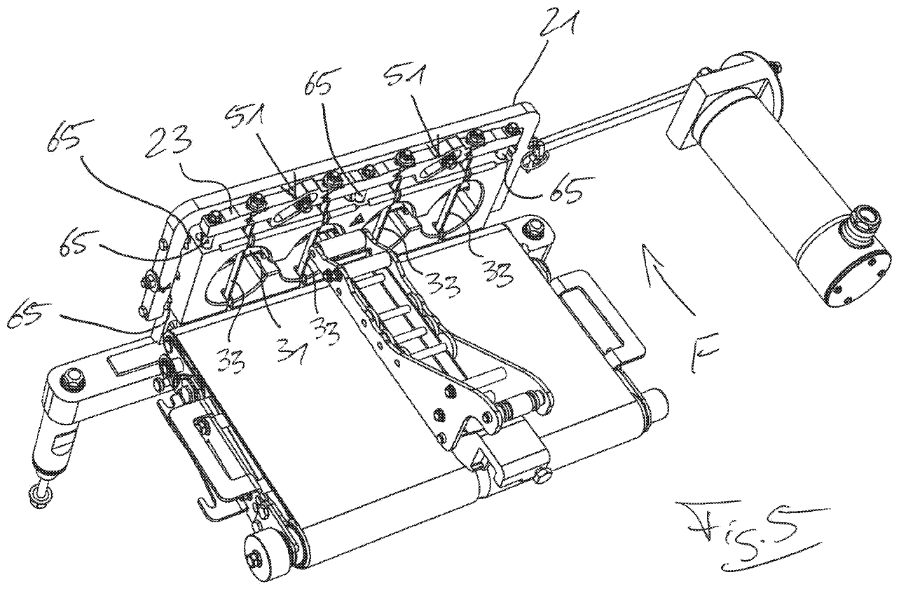

As can in particular be seen from FIGS. 4 and 5, which each show a perspective view obliquely from the rear at the top, the openings 49 adjoin a front part of the product support 14, wherein this front part is configured as a removable belt unit, which is generally known so that it is not necessary to look at this in more detail.

A dividing device 19 in accordance with the invention (cf. in particular FIG. 2) is integrated into the cutting spectacles 47 such that a first holder part 21 and a second holder part 23 are each displaceably supported at the cutting spectacles 47.

For this purpose, the first holder part 21 is formed in the manner of a hoop or a frame and comprises a horizontal section extending above the cutting spectacles 47 and two lateral vertical sections that are connected to one another by an upper guide rod 65 and a lower guide rod 65, wherein these horizontal guide rods 65 are guided through the cutting spectacles 47 above or below the openings 49. Due to this rod guide, the first holder part 21, which engages over the cutting spectacles 47 from above in the manner described, is movably guided in the horizontal direction relative to the cutting spectacles 47.

As in particular FIGS. 4 and 5 show, the second holder part 23 comprises a horizontally extending horizontal section that is connected to two lateral guide rods 65 and a central guide rod 65, wherein these guide rods 65 extend in the vertical direction and are likewise—like the guide rods 65 of the first holder part 21—guided through the cutting spectacles 47.

Viewed in the feed direction F, the second holder part 23 is located in front of the first holder part 21 so that the guide rods 65 of the first holder part 21, on the one hand, and the guide rods 65 of the second holder part 23, on the other hand, extend in planes that are spaced apart in parallel and that each extend in parallel with the cutting plane, not shown.

Between the two vertical sections of the first holder part 21, an elongated separation element 31 is clamped that extends approximately centrally through all the openings 49 (cf. in particular FIG. 6), i.e. that transverses all the openings 49, and that can—as already mentioned—be configured, for example, as a knife, a blade, a saw blade, or a wire.

The second holder part 23 is provided with four vertical elongated separation elements 33 that are each clamped between the horizontal section of the second holder part 23 extending above the cutting spectacles 47 and a lower section, not shown, of the second holder part 23. The vertical separation elements 33, which are likewise, for example, configured as a cutting edge, as a blade, as a saw blade or as a wire, each extend centrally through a respective opening 49, i.e. each opening 49 is traversed horizontally by the common separation element 31 and vertically by a respective separate separation element 33.

The two holder parts 21, 23 together with their separation elements 31, 33 consequently form a grating whose movability will be looked at in more detail below and by which four products 11 to be sliced can each be quartered simultaneously. In FIG. 6, this is indicated at the left opening 49. The front product end is quartered by the separation elements 31, 33 extending perpendicular to one another, i.e. is divided into four product parts 27 that are cut off from the front product end by means of the cutting blade, not shown.

The first holder part 21 can be excited to perform horizontal to-and-fro movements by means of a servomotor 35 forming a controllable drive. For this purpose, an output shaft (not shown) of the servomotor 35, which rotates about an axis of rotation 37 when the servomotor 35 is running, is connected to an eccentric element 41 to which a coupling rod 43 is connected in an articulated manner. The eccentric element 41 and the coupling rod 43 form a transmission 39, namely a thrust crank drive, between the servomotor 35 and the first holder part 21, wherein the servomotor 35 and the transmission 39 together form the drive 25 for the first holder part 21.

The eccentricity of this thrust crank drive is determined by the spacing between the axis of rotation 37 and the eccentric axis 63 of the eccentric element 41 about which the coupling rod 43 can be rotated with its one end due to the articulated connection. This eccentricity is comparatively small and can—as already mentioned in the introductory part—be between 2 and 15 mm, for example.

With its other end, the coupling rod 43 is connected in an articulated manner to one of the two lateral vertical sections of the first holder part 21. With this servomotor drive 25, the first holder part 21 can consequently be excited to perform periodic to-and-fro movements at a dividing frequency determined by the rotational speed of the output shaft of the servomotor 35, wherein the horizontal stroke of this to-and-fro movement of the first holder part 21 amounts to twice the eccentricity mentioned and is therefore between 4 and 30 mm in the embodiment described here.

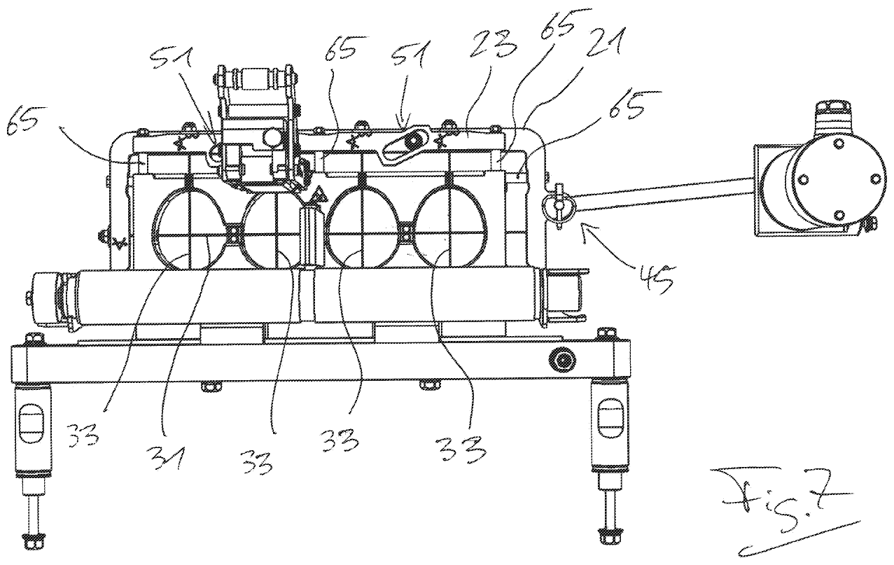

As can in particular be seen from FIGS. 6 and 7, the point of engagement 45 of the coupling rod 43 at the first holder part 21 is somewhat lower than the axis of rotation 37 (cf. FIG. 2) of the output shaft of the servomotor 35. Furthermore, this axis of rotation 37 does not extend exactly in parallel with the feed direction F. The positioning and orientation of the servomotor 35 relative to the cutting spectacles 47 and thus to the first holder part 21, which is excited directly by means of the servomotor 35, can in particular be varied in accordance with the respective requirements.

The excitation of the second holder part 23 does not take directly by means of the servomotor 35, but by the first holder part 21. As can in particular be seen from FIGS. 4, 5 and 7, the two holder parts 21, 23 are mechanically positively coupled to one another by two slot guides 51. Each slot guide 51 comprises an elongated hole which is formed at the horizontal section of the second holder part 23 and into which a section of the first holder part 21 acting as a sliding block projects.

Due to these slot guides 51, the horizontal to-and-fro movements of the first holder part 21 are converted into to-and-fro movements of the second holder part 23 perpendicular thereto. The transmission ratio can be predefined by the design of the slot guides 51. For example, the transmission ratio can amount to i=2 so that the stroke of the second holder part 23 amounts to half the stroke of the first holder part 21.

With regard to the possible values for the cutting frequency of the cutting blade 15 (cf. FIG. 1) and the dividing frequency of the to-and-fro movements of the two holder parts 21, 23 that can be generated by means of the servomotor 35 and with regard to the advantageous possibilities that can be realized by using a controllable drive—here the servomotor 34—for the dividing device in accordance with the invention, reference is also made to the explanations in the introductory part.

### REFERENCE NUMERAL LIST

11 product

13 product feed

14 product support

17 cutting blade

17 cutting plane

19 dividing device

21 holder part

23 holder part

25 drive

27 product part

29 control device

31 separation element

33 separation element

35 servomotor

37 axis of rotation

39 transmission

41 eccentric element

43 coupling element, coupling rod

45 point of engagement

47 product passage, cutting spectacles

49 passage, opening

51 slot guide

53 product holder

55 frame

57 portion

59 portioning belt

61 carrier

63 eccentric axis

65 guide rod

F feed direction

1. An apparatus for the single-track or multi-track slicing of food products,
having a product feed that feeds products to be sliced and disposed on a product support on one track or on multiple tracks in a feed direction to a cutting region in which a cutting blade moves in order to slice the fed products in a cutting plane, which extends perpendicular to the feed direction, at a predefined or predefinable cutting frequency by means of the cutting blade; and
having a dividing device that has at least one holder, which is arranged in the region of the cutting plane, for at least one elongated separation element, which extends in a dividing plane extending in parallel with the cutting plane, and a drive for the holder by which the holder can be excited to perform to-and-fro movements perpendicular to the feed direction at a dividing frequency in order to divide the front ends of the products by means of the separation element in parallel with the feed direction so that, in a respective cutting process, a plurality of product parts are cut off from a respective front product end by means of the cutting blade,
further having a control device, with the drive for the holder comprising a drive that can be controlled by means of the control device.

2. The apparatus in accordance with claim 1,
wherein the drive is a servomotor.

3. The apparatus in accordance with claim 1,
wherein the control device is configured to control the controllable drive in dependence on a respective current cutting operation.

4. The apparatus in accordance with claim 3,
wherein the control device is configured to control the controllable drive in dependence on a respective current cutting operation in dependence on the cutting frequency of the cutting blade, and/or on the position of the cutting blade in the cutting plane relative to the product feed, and/or on the operating state of the product feed, and/or on whether product parts are currently being cut off or are not being cut off, and/or on data determined by means of the controllable drive and in particular relating to forces acting on the separation element.

5. The apparatus in accordance with claim 1,
wherein the holder can be excited to a dividing frequency of more than 300 H/min.

6. The apparatus in accordance with claim 1,
wherein the control device is configured to excite the holder in a controlled manner such that the to-and-fro movements of the holder are synchronized with the cutting movements of the cutting blade, and/or wherein the control device is configured to excite the holder at a dividing frequency that is equal to the cutting frequency of the cutting blade, or such that the dividing frequency is a whole-number multiple of the cutting frequency of the cutting blade.

7. The apparatus in accordance with claim 1,
wherein an axis of rotation of a drive member of the drive intersects the cutting plane.

8. The apparatus in accordance with claim 1,
wherein the controllable drive is drive-effectively connected to the holder via a mechanical transmission.

9. The apparatus in accordance with claim 8,
wherein the transmission comprises an eccentric element.

10. The apparatus in accordance with claim 8,
wherein a coupling element of the transmission is, with its one end, eccentrically connected in an articulated manner to a drive member of the drive rotating about an axis of rotation, with respect to the axis of rotation and, with its other end, engages directly or indirectly at the holder.

11. The apparatus in accordance with claim 9,
wherein the eccentricity is between 2 mm and 20 mm.

12. The apparatus in accordance with claim 1,
wherein the holder is arranged at a single-part or multi-part product passage, which forms the front end of the product feed and is configured to support the front product ends, such that the holder performs the to-and-fro movements relative to the product passage, wherein the product passage has a passage for a respective front product end for the or each track and the elongated separation element traverses the or each passage.

13. The apparatus in accordance with claim 12,
wherein the or each passage is formed by a circular, oval, egg-shaped, square or rectangular opening that is bounded by an interrupted or uninterrupted peripheral support surface for a respective front product end in order to support a respective product end all around, with or without interruptions in the peripheral direction.

14. The apparatus in accordance with claim 12,
wherein the product passage is arranged in front of the cutting plane, viewed in the feed direction, and/or wherein the product passage is configured as a counter-blade for the cutting blade that cooperates with the cutting blade for the cutting off of the product parts from the front product ends.

15. The apparatus in accordance with claim 12,
wherein the elongated separation element extends within the product passage so that the elongated separation element traverses the or each passage, viewed in the feed direction, between an entry plane into the passage and an exit plane from the passage.

16. The apparatus in accordance with claim 12,
wherein the or each passage is traversed by a plurality of elongated separation elements that extend at an angle different from zero to one other and in dividing planes spaced apart in parallel from one another.

17. The apparatus in accordance with claim 12,
wherein, in a multi-track design, the product passage has a passage for each track and all the passages are traversed, on the one hand, by a common elongated separation element extending in a first direction and each passage is additionally traversed by a further elongated separation element extending in a second direction that is different from the first direction.

18. The apparatus in accordance with claim 1,
wherein the holder comprises a first holder part having at least a first elongated separation element and a second holder part movable relative to the first holder part and having at least a second elongated separation element that does not extend in parallel with the first elongated separation element.

19. The apparatus in accordance with claim 18,
wherein both holder parts are arranged at a product passage, wherein the product passage forms the front end of the product feed and is configured to support the front product ends, such that the holder performs the to-and-fro movements relative to the product passage, wherein the product passage has a passage for a respective front product end for the or each track and the elongated separation element traverses the or each passage.

20. The apparatus in accordance with claim 18,
wherein the two holder parts are mechanically coupled to one another such that a to-and-fro movement of the one holder part taking place in a first direction is converted into a to-and-fro movement of the second holder part taking place in a second direction that is different from the first direction.

21. The apparatus in accordance with claim 18,
wherein the first holder part is excited by means of the drive to perform the to-and-fro movement, in particular horizontal to-and-fro movement, taking place in the first direction that is converted into the to-and-fro movement of the second holder part taking place in the second direction.

22. A method for the single-track or multi-track slicing of food products by means of a slicing apparatus, in particular configured in accordance with any one of the preceding claims, in which the products to be sliced and disposed on a product support are fed by means of a product feed on one track or on multiple tracks in a feed direction to a cutting region in which a cutting blade moves in order to slice the fed products in a cutting plane, which extends perpendicular to the feed direction, by means of the cutting blade,
wherein a dividing device is provided that has at least one holder, which is arranged in the region of the cutting plane, for at least one elongated separation element that extends in a dividing plane extending in parallel with the cutting plane,
wherein the holder is excited by means of a controllable drive to perform to-and-fro movements perpendicular to the feed direction at a dividing frequency in order to divide the front ends of the products by means of the separation element in parallel with the feed direction so that, in a respective cutting process, a plurality of product parts are cut off from a respective front product end by means of the cutting blade.

23. The method in accordance with claim 22,
in which the controllable drive is controlled in dependence on a respective current cutting operation by means of a control device, and/or in which the to-and-fro movements of the holder are synchronized with the cutting movements of the cutting blade.
